(19) United States
(12) Patent Application Publication
(10) Pub. No.: US 2003/0183652 A1
(43) Pub. Date: Oct. 2, 2003

(54) Dual diluent post-mix beverage dispenser

(76) Inventors: Peter S. Tinucci, Glendale Heights, IL (US); David W. Berend, Algonquin, IL (US)

Correspondence Address: Sten Erik Hakanson, Patent Attorney, IMI Cornelius Inc., One Cornelius Place, Anoka, MN, 55303-6234, US

(21) Appl. No.: 10/404,505

(22) Filed: Mar. 26, 2003

Related U.S. Application Data
(60) Provisional application No. 60/368,281, filed on Mar. 27, 2002.

(51) Int. Cl. B67D 5/56

(52) U.S. Cl. 222/129.1

(57) ABSTRACT

A dual diluent manifold is mounted within the dispenser at a front end thereof. A plurality of post-mix beverage dispensing valves are mounted there above on a front surface of the dispenser. The manifold consists of an elongate rectangular block machined or molded to include a plain water channel and a carbonated water channel extending along the length thereof and along a bottom portion thereof. Each channel is in fluid communication with a plurality of holes or orifices that extend downward from a top surface of the manifold and transversely to their respective channel. As a result thereof there exist orifice pairs extending along the manifold, one of which fluidly communicates with the plain water channel and one of which communicates with the carbonated water channel. The plain and carbonated water channels have inlet ends for receiving fittings for connection with tubing that extend to cooled sources of plain and carbonated water respectively. Water outlet fittings provide for quick insertion fluid tight connection of flexible supply water tubes to one of the plain or carbonated water orifices. The supply water tubes also have inlet fitting on the opposite ends thereof for fluid tight securing with the inlets that communicate diluent to each post-mix valve. Stop plugs provide for blocking any flow of water from the plain or carbonated water orifices that are not supplying diluent to a valve. A removable retainer is used to hold each of the water outlet fittings and stop plugs in place so that the fluid tight securing thereof with each manifold orifice is maintained. The retainer can be released so that outlet fittings and stop plugs can be removed and exchanged positions in the manifold to permit change over of the fluid being sent to a valve.

### FIELD OF THE INVENTION

The present invention relates generally to beverage dispensing equipment and more particularly to post-mix beverage dispensing equipment have the capacity to change between the dispensing of carbonated and non-carbonated drinks.

### BACKGROUND

Post-mix beverage dispensing equipment is well known in the art and generally provides for the mixing of a diluent, consisting of a carbonated or flat water, with a flavoring syrup. Post-mix valves are secured to a dispenser body or frame to which a diluent water line and a syrup line are plumbed. In past dispensers, each valve was dedicated to either dispensing a carbonated or a non-carbonated drink. However, today there is great desire to have the flexibility to be able to change between dispensing carbonated drinks, such a s soda pop, to noncarbonated drinks, such as juice and sports beverages with the same valve. Various attempts have been made to allow changeover between plain water and carbonated water lines so that each valve has the potential to dispense either carbonated or plain water based drinks. However, problems have arisen as to cost, mechanical complexity, lack of ability to be able to convert all the valves on a particular dispenser, and ease with which service personnel can effect the change over. Accordingly, it would be very desirable to have a post-mix beverage dispenser that overcomes these drawbacks.

### SUMMARY OF THE INVENTION

The present invention concerns a post-mix beverage dispenser having a plurality of beverage dispensing valves that are easily changed over between dispensing carbonated or non-carbonated drinks. In the preferred embodiment, a dual diluent manifold is mounted within the dispenser at a front end thereof. A plurality of post-mix beverage dispensing valves are mounted there above on a front surface of the dispenser. The manifold consists of an elongate rectangular block machined or molded to include a plain water channel and a carbonated water channel extending along the length thereof and along a bottom portion thereof. Each channel is in fluid communication with a plurality of holes or orifices that extend downward from a top surface of the manifold and transversely to their respective channel. Thus, there exist orifice pairs extending along the manifold, one of which fluidly communicates with the plain water channel and one of which communicates with the carbonated water channel. The plain and carbonated water channels have inlet ends for receiving fittings for connection with tubing that extend to cooled sources of plain and carbonated water respectively.

Water outlet fittings provide for quick insertion fluid tight connection of flexible supply water tubes to one of the plain or carbonated water orifices. The water supply tubes also have an inlet fitting on the opposite end thereof for fluid tight securing with an inlet that communicates diluent to each post-mix valve. Stop plugs provide for blocking any flow of water from the plain or carbonated water orifices that are not supplying diluent to a valve. A removable retaining means is used to hold each of the water outlet fittings and stop plugs in place so that the fluid tight securing thereof with each manifold orifice is maintained.

In operation, those of skill will understand that the retaining means can be released to permit service personnel to, for example, remove a water outlet fitting connected with a carbonated water orifice and to remove the stop plug from the corresponding plain water orifice. Each can then be exchanged with the other whereby the water outlet is now inserted into and retained in the plain water orifice and the stop plug is inserted into and retained in the carbonated water orifice. After replacing of the retaining means the particular post-mix valve formerly receiving carbonated water is now receiving plain water. In this manner, every post-mix valve on the dispenser is then fully capable of dispensing either carbonated or noncarbonated drinks. Moreover, the front end location of the manifold along with the easily inserted and removed water outlet fittings and stop plugs, and the easily removable and replaceable retaining means permit this change over to be done quickly and efficiently in the field. Those of skill will also appreciate that the manifold and associated components are simple and inexpensive to manufacture. Also, it can be understood that existing dispensers can be retrofitted with change over device of the present invention. Additionally, the present invention can be used with electrically cooled as well as ice cooled beverage dispensers.

### DESCRIPTION OF THE DRAWINGS

A better understanding of the structure, function and operation as well as the objects and advantages of the present invention can be had by reference to the following detailed description that refers to the following figures, wherein:

FIG. 1 shows a perspective view of a dispenser utilizing the present invention.

FIG. 2 front plan view of the dispenser of FIG. 1 and having various components thereof removed.

FIG. 3 shows a side plan view along lines 3-3 of FIG. 2

FIG. 4 shows an enlarged front plan view of a dual diluent manifold and associated mounting structure.

FIG. 5 shows an end a cross-sectional view of the manifold along lines 5-5 of FIG. 4.

FIG. 6 shows an enlarged end plan view of the manifold.

FIG. 7 shows a longitudinal cross-sectional view along lines 7-7 pf FIG. 6.

FIG. 8 shows a top plan view of the manifold along lines 8-8 of FIG. 4.

FIG. 9 shows a perspective view of the retaining plate.

FIG. 10 shows a plan view of a water outlet and associated flexible diluent hose and post-mix valve inlet.

FIG. 11 shows a schematic diagram of the fluid connections of the present invention.

### DETAILED DESCRIPTION OF THE PREFERRED EMBODIMENT

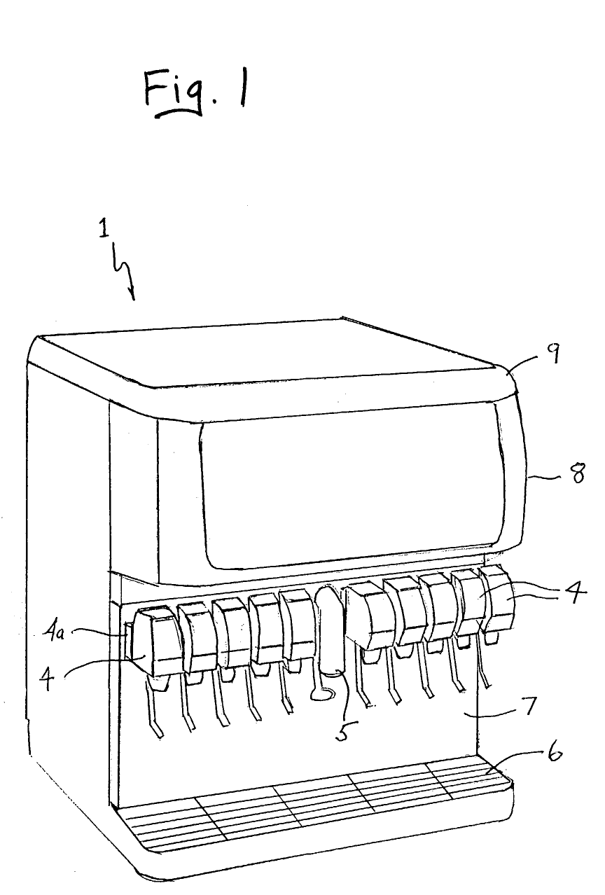

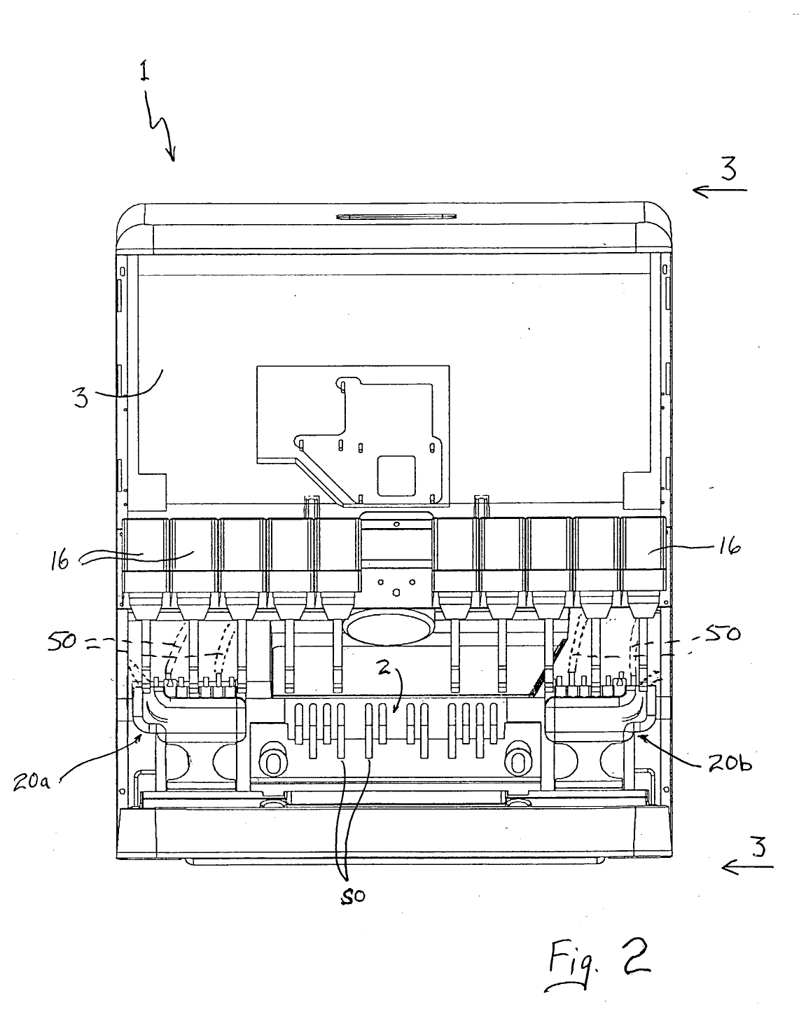

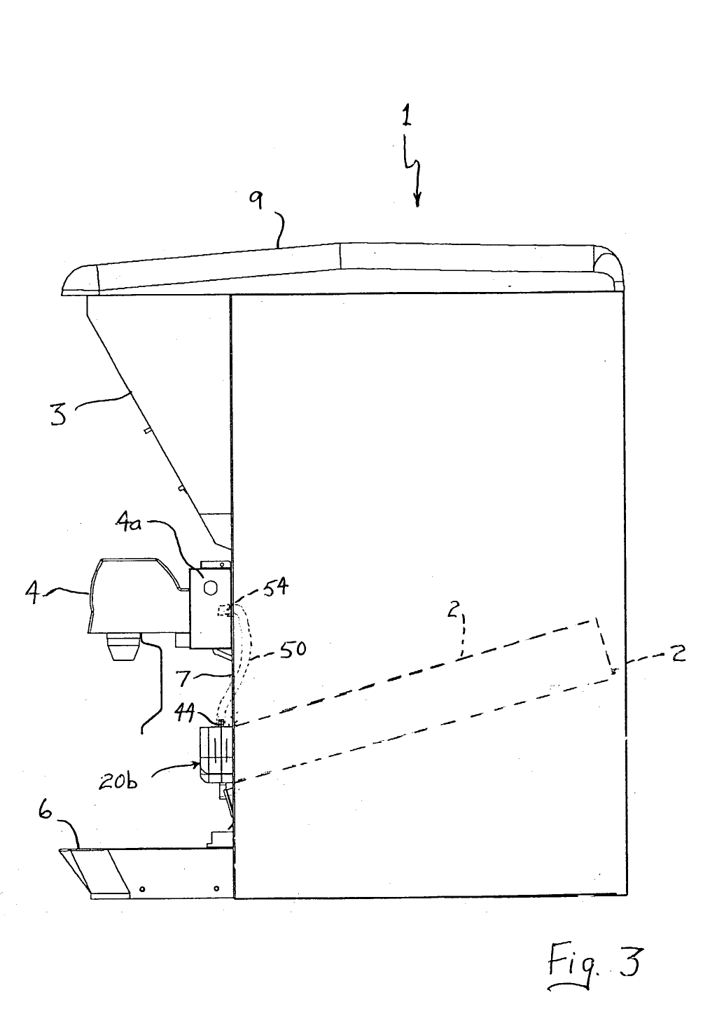

The change over device of the present invention is shown in the various figures in the context of an ice-cooled combination ice/beverage dispenser 1. As seen by specifically referring to FIGS. 1, 2, 3 and 11, and as is well understood in the art, dispenser 1 includes a cold plate 2, an ice retaining bin 3 there above. A plurality of post-mix beverage dispensing valves 4 are secured to a front end thereof by valve disconnect blocks 4a. A more detailed understanding of the structure and operation of a post-mix valve and its mounting to a beverage dispenser can be had by referring, for example, to U.S. Pat. No. 5,285,815 which is incorporated herein by reference thereto. An ice dispensing chute 5 is positioned between valves 4 and all are positioned above a drip tray 6. Dispenser 1 also includes a splash panel 7, a merchandiser cover 8 and a top cover 9.

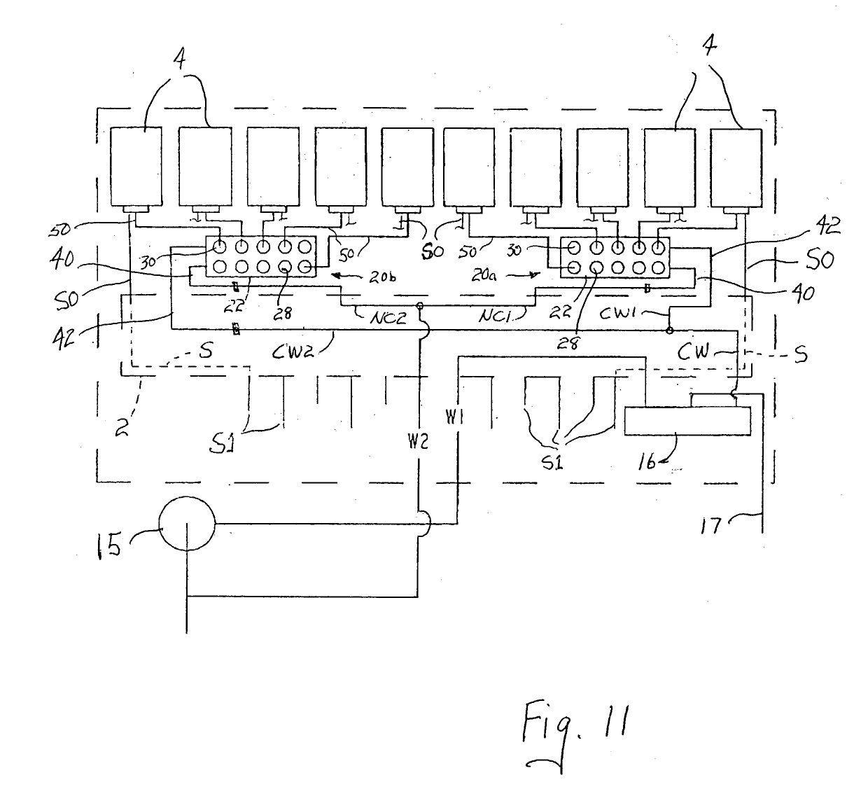

As is well known, and as understood by referring to FIG. 11, cold plate 2 includes a plurality of serpentine syrup and diluent heat exchange coils. Syrup coils S have a plurality of inlets S1 and outlet lines SO. Cold plate 12 also includes two water lines W1 and W2. Water line W1 receives potable water from a pump 15 connected to a mains water supply. Water flows along line W1 and is pre-cooled by passage through cold plate 2 and is then delivered to a carbonator 16. Pressurized carbon dioxide gas is supplied from a source thereof, not shown, to carbonator 16 through inlet 17 thereof. Carbonated water flows through a cold plate coil CW which then divides into two separate lines CW1 and CW2. Water line W2 is connected to the stated water mains directly and within cold plate 2 divides into two separate non-carbonated water lines NC1 and NC2. Syrup outlet lines SO are each connected to one of the valves 4.

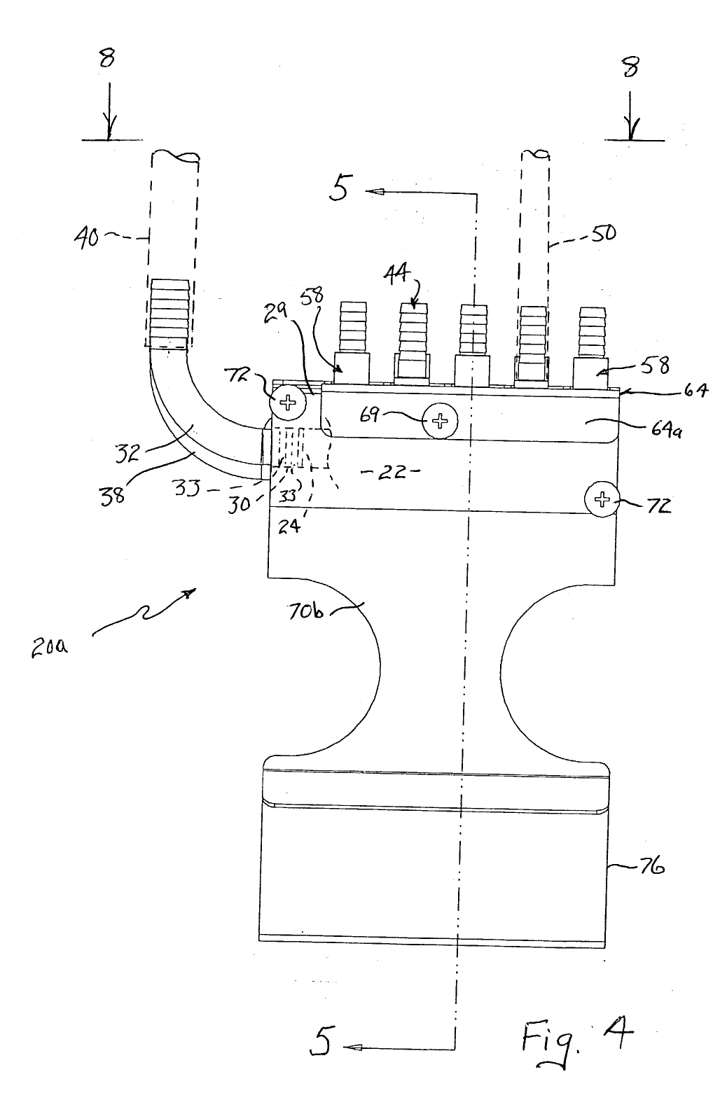

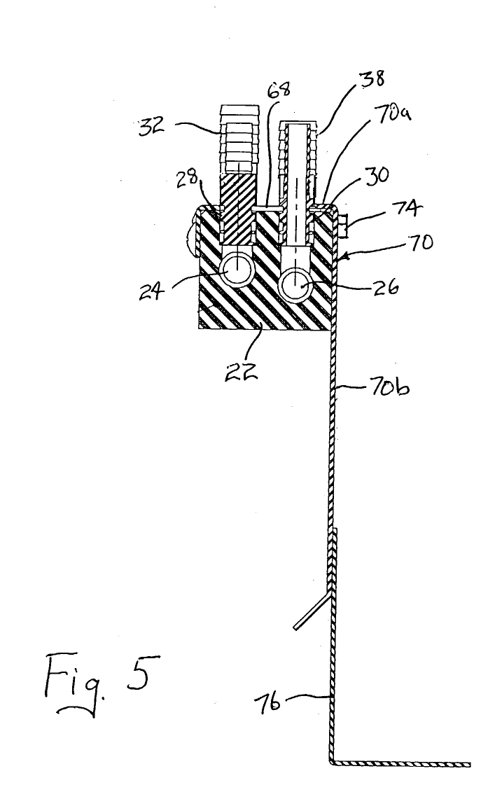

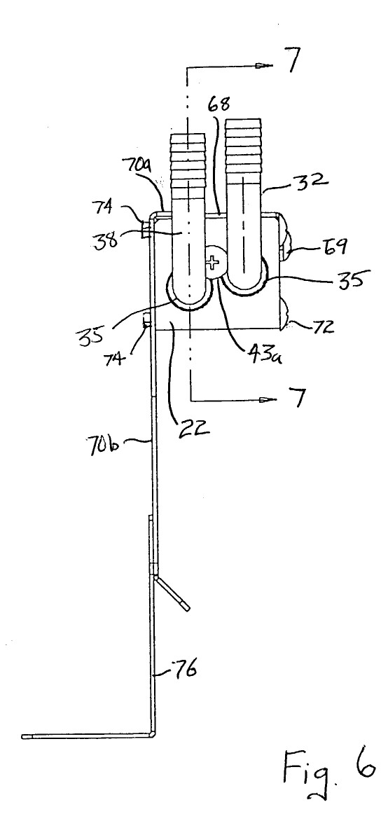

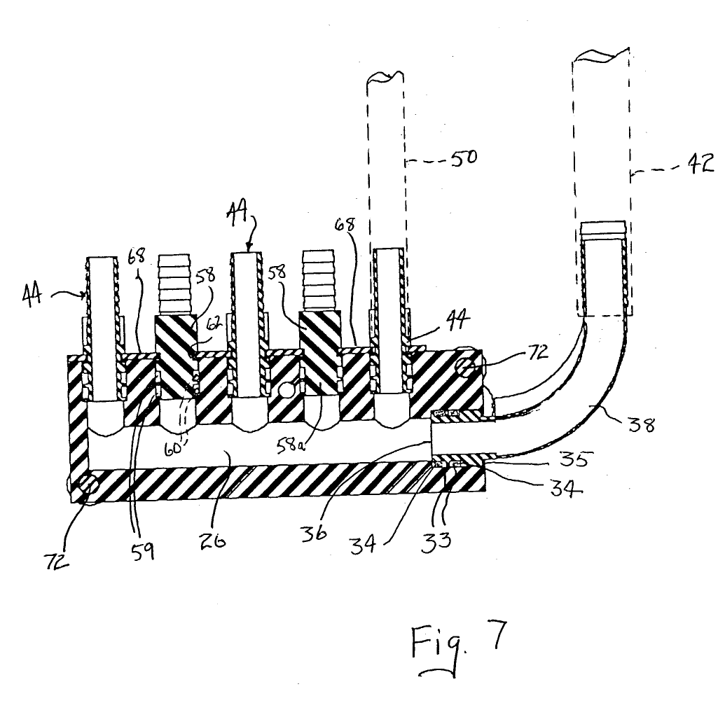

Dispenser 1 includes a pair of dual diluent manifold systems generally designated by the numerals 20a and 20b and each having an exterior molded insulation cover 21a and 21b that can be opened in a clam-shell fashion. Systems 20a and 20b are identical right and left hand versions of the other. Thus, system 20a will be described in further detail with the understanding that the description thereof will apply equally to its mirror image counterpart 20b. As better understood by also referring to FIGS. 4-8, after removing insulation 21a, system 20a includes a rectangular dual diluent manifold block 22 having a plain water channel 24 and a carbonated water channel 26 extending there along and there through. A plurality of plain water outlet retaining orifices 28 extend transversely from a top surface 29 of manifold block 22 and intersect with plain water channel 24. Likewise, an equal plurality of carbonated water outlet retaining orifices 30 extend from surface 29 transversely to and intersects fluidly with carbonated water channel 26. It can be seen that the plain and carbonated water outlet retaining orifices 24 and 26 respectively, form orifice pairs along manifold block 22. Plain water channel 24 includes an open inlet end 30 for fluid tightly receiving an inlet fitting 32. Fitting 32 includes a pair of annular grooves 33 for retaining a pair of o-rings 34 and a top shoulder surface 35. In the same manner, carbonated water channel 26 includes and inlet end 36 for receiving an inlet fitting 38 identical to fitting 32. Both fittings 32 and 38 are in turn connected to flexible hoses 40 and 42 respectively. Also, fittings 32 and 38 are retained in channel ends 30 and 36 by a self-threaded screw 43 threaded into block 22 and including a screw head perimeter edge 43a for covering over a portion of each shoulder 35 of fittings 32 and 38 thereby retaining such in block 22. Hose 40 is fluidly connected to non-carbonated water line NC1 and hose 42 is fluidly connected to carbonated water line CW1. Those of skill will readily appreciate that hoses 40 and 42 could also be connected to plain water and carbonated water coils emanating from a cooled water bath of an electrically cooled beverage dispenser or to any sources of non-carbonated and carbonated water. Hoses 40 and 42 can also be insulated as by an insulating tape or wrap around the exterior thereof.

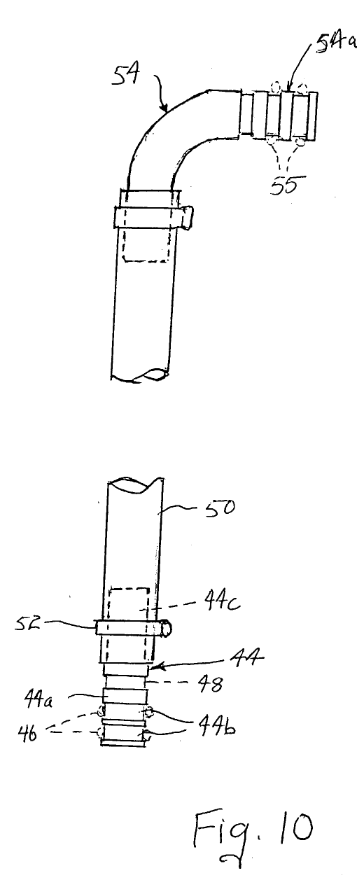

Outlet fittings 44 include an insertion end portion 44a having two annular grooves 44b for receiving o-rings 46 and includes an annular retainer groove 48. Fittings 44 also include a ferruled or barbed tube connection end portion 44c. As seen in FIG. 10, each outlet fitting 44 is secured by the connection end portion 44c to a flexible diluent hose 50 through the use of a suitable clamp or retaining band 52. Hose 50 is secured on its opposite end to a post-mix valve inlet fitting 54 also having a connection end portion 54a having annular grooves for retaining a pair of o-rings 55. As can also be well understood by referring to U.S. Pat. No. 5,285,815, fitting 54 provides for fluid connection with one of the valves 4. A plurality of stop plugs 58 are solid structures having an end portion 58a that, like outlet fitting 44, include annular grooves 59 for retaining a pair of o-rings 60 and includes an annular retaining groove 62. Hoses 50 can also be insulated.

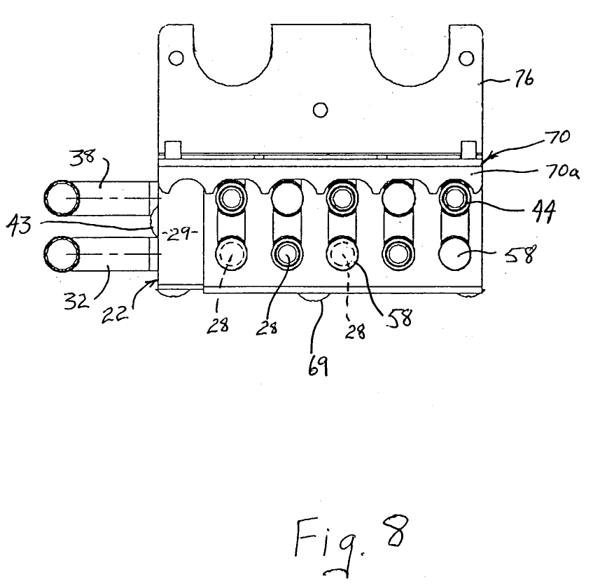

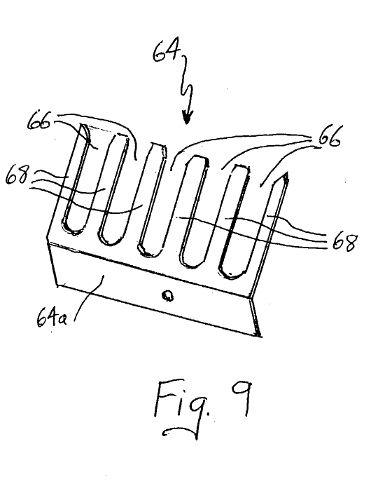

Fittings 44 and stop plugs 58 are sized to be fluid tightly inserted into either of the equally sized plain water and carbonated water outlet orifices 28 and 30. When fully inserted therein, it can be understood that a retainer plate 64, see also seen in FIG. 9, is used to retain fittings 44 and plugs 58 in fluid tight securing position in their respective plain or carbonated water orifices 28 and 30. In particular, plate 64 is L-shaped having a vertical flange portion 64a includes a plurality of slots 66 defined by fingers 68 extending transversely to flange portion 64a. Those of skill will understand that annular grooves 48 and 62 of outlet fittings 44 and stop plugs 58 respectively, receive portions of the perimeter edges of fingers 68. Thus, fingers 68 of retainer plate 64 can slide into grooves 48 and 62 once the slots 66 are registered with bodies of outlets 44 and stops 58. Plate 64 is then secured by a self-threading screw 69 to manifold block 22. With retaining plate 64 in place, as see for example in FIG. 8, it will be appreciated that outlets 44 and plugs 58 can not be removed from manifold block 22. A further secondary retaining plate 70 includes a top horizontal portion 70a and a major bracket portion 70b integral therewith and extending downwardly there from and transversely thereto. Bracket 70 is secured to manifold block 22 by two bolts 72 extending through block 22 and through bracket portion 70 and retained thereto by nuts 74. When in position, top horizontal portion 70a of bracket 70 serves to cover and hold down tip ends of fingers 68 to provide for additional secure retaining thereof, and in turn, retaining of outlets 44 and stops 58. Bracket 70 can also be secured to a further retaining bracket 76 as may be needed to provide for the securing and support of each manifold system to dispenser 10.

In operation, those of skill will appreciate that by the removal of retaining bracket 64, outlets 44 and stops 58 can be quickly removed from their respective outlet orifices 28 and 30 in which they are inserted. Thus, one outlet 44 can, for example, be removed from a carbonated water orifice 30 and a stop 58 can be removed from the correspondingly paired plain water outlet orifice 28. After which, the relative positions thereof can exchanged whereby the outlet 44 is now in the plain water orifice 28 and the stop 58 is then placed in the corresponding carbonated water orifice 30. The retaining bracket 64 is then reinserted and secured to block 22. Those of skill will understand that all the valves 4 can be easily and quickly changed over between plain or carbonated water in this manner wherein the flexible tubing 50 provide for and facilitates the necessary movement. It can also be seen that the system of the present invention can be retrofitted to existing electrically and ice cooled beverage dispensers. In the illustrated embodiment, two manifold systems 20a and 20b are used wherein each manifold block 22 serves five of the ten valves. The number of manifolds and the number of valves served by each are a matter of design skill for those in the art. It can also be understood that the manifold system of systems of the present invention can be placed at various locations within a dispenser. The placement at the front of dispenser 1 is preferred in that case due to the arrangement of the outlets from the cold plate 2 and access provided by the removable splash panel 8.

The present invention can also be used in any of a variety of general applications where either of two fluids are needed to be selectively sent to a mixing valve or outlet. In fact, it can be understood that block 22 could have any of a plurality of fluid channels connecting with one or more outlet orifices so that any of a plurality of diluents or specifically selected liquids could be selectively direct to one or more outlets, valves or the like.

In the claims:

1. A change over system for permitting the directing of either of two liquid diluents to any of one or more dispensing valves as secured to a beverage dispensing machine, comprising:
a manifold, having a first channel for a first liquid diluent and a fluidly separate second channel for a second liquid diluent, and the first channel having an inlet end for fluid tightly receiving a first inlet conduit connected to a source of the first liquid diluent, and the second channel having an inlet end for fluid tightly receiving a second inlet conduit connected to a source of the second liquid diluent, and the first channel in fluid communication with one or more first liquid diluent outlet orifices and the second channel in fluid communication with one or more second liquid diluent outlet orifices, one or more outlet fittings and one or more stop fittings releasably and securely fluid tightly securable with any of the one or more first or second liquid diluent outlet orifices, the outlet fittings for directing flow from one of the first or second liquid diluent outlet orifices to one or more diluent outlet conduits fluidly secured to each of the one or more outlet fittings and each of the one or more stop fittings for blocking flow from one of the one or more first or second outlet orifices to which it is secured, and each of the one or more outlet conduits fluidly connect to a dispensing valve.

2. The change over system as defined in claim 1 and the manifold first and second channel liquid diluent outlet orifices being paired along a length of the manifold whereby each one or more outlet conduits fluidly secured to a dispensing valve is alternatively fluidly connectable to either of a pair of first and second channel liquid diluent outlet orifices.

3. The change over system as defined in claim 1 and the manifold secured within the dispenser and the manifold and the inlet and outlet conduits being insulated.
